(19) United States
(12) Patent Application Publication
(10) Pub. No.: US 2015/0128404 A1
(43) Pub. Date: May 14, 2015

(54) JIG APPARATUS AND FASTENING METHOD USING THE SAME

(71) Applicant: SAMSUNG ELECTRONICS CO., LTD., Suwon-si (KR)

(72) Inventors: Jin Su Lee, Suwon-si (KR); Chan Geun Kim, Hwaseong-si (KR)

(73) Assignee: SAMSUNG ELECTRONICS CO., LTD.

(21) Appl. No.: 14/472,034

(22) Filed: Aug. 28, 2014

(30) Foreign Application Priority Data
Nov. 13, 2013 (KR) 10-2013-0137492

(51) Int. Cl. F16B 5/06; F16B 2/22

(52) U.S. Cl. CPC F16B 5/065; F16B 2/22
USPC 29/525.01; 24/530; 24/564

(57) ABSTRACT

A jig apparatus fastening loaded trays having light emitting devices received therein, includes a body and first and second extending portions. The body has a bent structure in a length direction thereof. The first and second extending portions are respectively bent and extend from a first end and a second end of the body in the length direction thereof.

### CROSS-REFERENCE TO RELATED APPLICATION

This application claims benefit of priority to Korean Patent Application No. 10-2013-0137492 filed on Nov. 13, 2013, with the Korean Intellectual Property Office, the entire content of which is incorporated herein by reference.

### TECHNICAL FIELD

The present disclosure relates to a jig apparatus and a fastening method using the same.

### BACKGROUND

In general, high-power and medium-power light emitting diode (LED) package products may be received in trays at the time of the shipment thereof, and the trays may be fastened together as a single bundle by a fastening binder for preventing movement thereof in a state in which a predetermined amount of trays are loaded. Then, the tray bundle maybe pressure-packed in a bag for blocking static electricity and direct light. In this case, the binder used to integrally fasten the loaded trays together may generally be antistatic tape, string, Magic Tape, a rubber band or the like.

However, in such a binding process using tape, since a taping operation is performed single-handedly by an operator in a state in which the loaded trays are grasped by an operator's remaining hand, the binding process may be unstable and problematic to perform. In addition, since the binding process may be performed in a state in which the trays are not stably fastened, the trays may be subject to external impacts, such that the packages received in the trays may be misaligned. Further, in some cases, defects such as breakage of package products may occur.

### SUMMARY

An aspect of the present disclosure may provide an apparatus capable of simply fastening loaded trays and a fastening method using the same.

One aspect of the present disclosure relates to a jig apparatus fastening loaded trays having light emitting devices received therein, including a body and first and second extending portions. The body has a bent structure in a length direction thereof. The first and second extending portions are respectively bent and extend from a first end and a second end of the body in the length direction thereof.

The body may be bent at a predetermined angle, with respect to a center of a first surface thereof.

The angle may range from 169° to 175°.

The first and second extending portions may respectively extend from the first surface of the body.

The body may have a stepped structure in which a second surface of the body protrudes along a circumference of an edge of the second surface.

The body may include windows penetrating therethrough.

The windows may be respectively provided in regions between a central portion of the body in the length direction thereof and both ends of the body.

The body may include concave portions recessed toward centers of both side surfaces connecting both ends thereof.

The body may include through holes in the first and second ends thereof connected to the first and second extending portions, the through holes penetrating through the body.

The body may include an acrylonitrile-butadiene-styrene (ABS) resin, a polypropylene (PP) resin, a polycarbonate (PC) resin, a polyamide (PA) resin, or the like.

The first and second extending portions may include respective hooks protruding from one surfaces of the first and second extending portions, such that the respective hooks face each other.

Another aspect of the present disclosure encompasses a fastening method including preparing a laminate by loading a plurality of trays in which light emitting devices are received. A first jig apparatus is prepared including a body having a bent structure by bending a central portion of the body so as to protrude toward a first surface of the body, and first and second extending portions respectively bent and extending from a first end and a second end of the body in a length direction thereof. The extending portions are allowed to be engaged with and fixed to protrusions respectively provided on edges of one ends of an upper tray and a lower tray among the plurality of trays loaded in the laminate, while pre-fastening the first jig apparatus to one end of the laminate such that a protruding surface of the body is outwardly disposed. A second jig apparatus is pre-fastened to an other end of the laminate, opposing to the one end of the laminate. The first jig apparatus is fastened to the laminate by applying pressure to a center of the first surface of the body in such a manner the protruding central portion of the body protrudes toward a second surface of the body.

The body may be bent at a predetermined angle based on the central portion thereof, and the angle may range from 169° to 175°.

The first and second extending portions may include respective hooks protruding from surfaces of the first and second extending portions, such that the respective hooks face each other.

Each of the light emitting devices may include a substrate and an LED chip mounted on the substrate.

Still another aspect of the present disclosure relates to a jig apparatus fastening loaded trays having light emitting devices received therein, includes a body and extending portions. The body has a first surface and a second surface opposing the first surface. The extending portions extend from the first surface of the body in an extending direction. The body has a bent structure with respect to a central portion of the body such that when both ends of the body are fastened, the central portion moves from a position protruding toward the second surface of the body in a direction opposite to the extending direction, to a position protruding toward the first surface in the extending direction.

### BRIEF DESCRIPTION OF DRAWINGS

The above and other aspects, features and other advantages of the present disclosure will be more clearly understood from the following detailed description taken in conjunction with the accompanying drawings, in which like reference characters may refer to the same or similar parts throughout the different views. The drawings are not necessarily to scale, emphasis instead being placed upon illustrating the principles of the embodiments of the present inventive concept. In the drawings, the thickness of layers and regions maybe exaggerated for clarity.

FIG. 1 is a schematic perspective view of a jig apparatus according to an exemplary embodiment of the present inventive concept.

FIG. 2 is a perspective view illustrating the jig apparatus of FIG. 1 when viewed in an opposite direction to FIG. 1.

FIG. 3 is a schematic side view of the jig apparatus of FIG. 1.

FIGS. 4A and 4B are side views schematically illustrating operational states of the jig apparatus.

FIG. 5 is a schematic perspective view of a laminate in which trays having light emitting devices received therein are loaded.

FIG. 6 is a perspective view schematically illustrating a process in which the jig apparatus is pre-fastened to the tray laminate of FIG. 5.

FIG. 7 is a perspective view schematically illustrating a process in which the jig apparatus of FIG. 6 is fastened to the laminate.

### DETAILED DESCRIPTION

Exemplary embodiments of the present inventive concept will now be described in detail with reference to the accompanying drawings.

The disclosure may, however, be exemplified in many different forms and should not be construed as being limited to the specific embodiments set forth herein. Rather, these embodiments are provided so that this disclosure will be thorough and complete, and will fully convey the scope of the disclosure to those skilled in the art.

In the drawings, the shapes and dimensions of elements may be exaggerated for clarity, and the same reference numerals will be used throughout to designate the same or like elements.

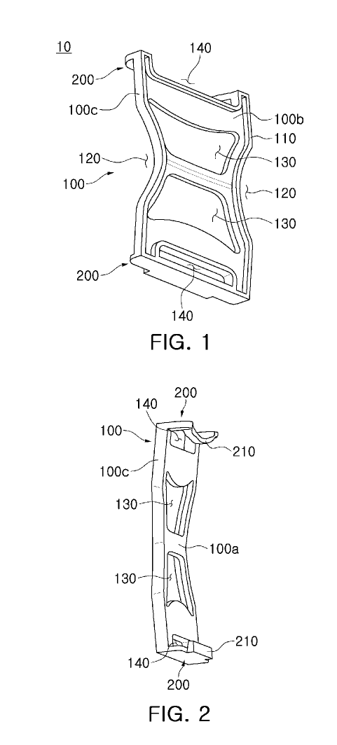

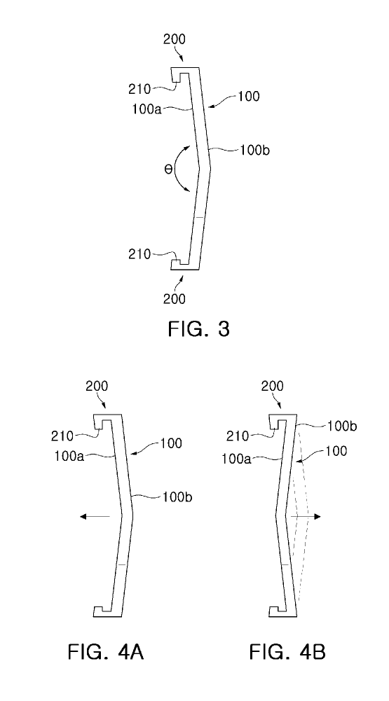

A jig apparatus according to an exemplary embodiment of the present inventive concept will be described with reference to FIGS. 1 through 3. FIG. 1 is a schematic perspective view of a jig apparatus according to an exemplary embodiment of the present inventive concept. FIG. 2 is a perspective view illustrating the jig apparatus of FIG. 1 viewed in an opposite direction to FIG. 1. FIG. 3 is a schematic side view of the jig apparatus of FIG. 1.

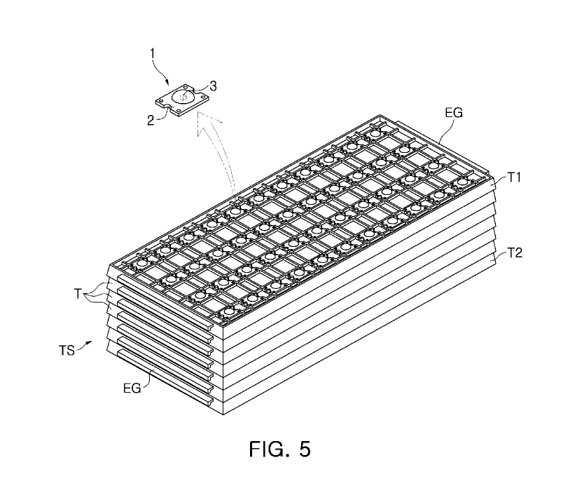

Referring to FIGS. 1 through 3, a jig apparatus 10 according to an exemplary embodiment of the present inventive concept may include a body 100 having a non-planar structure in a length direction thereof and extending portions 200 provided on edges of both ends of the body 100 in the length direction thereof. The jig apparatus 10 may be used to integrally fasten a laminate TS (see FIG. 5) formed by stacking a plurality of trays T in which light emitting devices 1 are received, therein.

In particular, the jig apparatus 10 according to an exemplary embodiment of the present inventive concept may have a one-touch type fastening structure using tension generated through a spring back phenomenon.

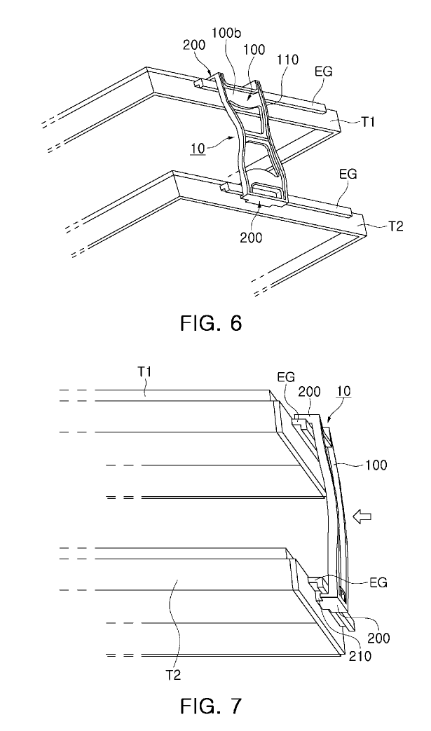

As illustrated in FIG. 5, the trays T may be used to receive and store a plurality of the light emitting devices 1 therein to be carried and may be fastened as a single bundle by jig apparatuses 10 fastened to both opposite ends of the trays when the trays T are loaded in multiple layers (see FIG. 6). The trays T may include protrusions EG respectively protruding from edges of both ends thereof, for example, in the form of edge guides, in order to be fastened to the jig apparatus 10.

Hereinafter, a structure of the jig apparatus 10 will be described in detail.

The body 100 may be a frame structure having a predetermined length corresponding to a height of the laminate TS.

As illustrated in FIG. 3, the body 100 may have a non-planar structure in the length direction thereof in order to implement a spring back phenomenon. In detail, the body 100 maybe concavely bent at a predetermined angle (θ), with respect to the center of one surface 100a thereof and for example, may have a V-Shaped structure.

Here, the angle (θ) may range from 169° to 175°.

When the angle (θ) is below 169°, values of tensile stress applied to the jig apparatus 10 may be excessively increased, a portion between the body 100 and the extending portions 200 may be broken at the time of fastening the jig apparatus 10. In addition, a user's excessive force may be required in the fastening of the jig apparatus 10.

Meanwhile, when the angle (θ) is greater than 175°, a degree of deformation sufficient to implement a spring back phenomenon may not be generated. That is, the values of tensile stress of the jig apparatus 10 maybe decreased, such that a degree of tension sufficient to fasten the loaded trays T may not occur, thereby leading to an inability to secure a stable fixation of the trays T.

The body 100 may include a side wall 110 (see FIG. 1) on the other surface 100b thereof and have a stepped structure, the side wall 110 protruding from the other surface 100b along a circumference of an edge of the other surface 100b. That is, the body 100 may have a box-shaped structure including the side wall 110 and a bottom surface corresponding to the surface of the other surface 100b surrounded by the side wall. When the body 100 has a stepped structure in which the circumference of the edge of the surface protrudes outwardly, the body 100 may not be easily damaged by tension and bending force repeatedly acting thereon or impacts applied to a side surface thereof, and may be structurally stably maintained.

Meanwhile, the body 100 may include concave portions 120 recessed toward the centers of both side surfaces 100c that connect both ends of the body 100 in the length direction. The concave portions 120 may be provided to face each other in the centers of the both side surfaces 100c of the body 100.

The body 100 may include windows 130 penetrating therethrough. The windows 130 may be provided in a region between a central portion of the body 100 and one end of the body 100 in the length direction and in a region between the central portion of the body 100 and the other end of the body 100 in the length direction. That is, the windows 130 may be respectively provided in left and right sides of the central portion of the body 100.

The windows 130 may prevent the jig apparatus 10 from being warped in injection-molding and manufacturing processes of the jig apparatus 10. That is, when the body 100 has reduced thicknesses (e.g., a thicker portion of approximately 2.3 mm and a thin portion of approximately 1 mm), in a case in which the body 100 is injection-molded without having the windows 130, the body 100 may be significantly warped due to the reduced thicknesses thereof. Therefore, the windows 130 may be provided to prevent the occurrence of warpage.

The body 100 may include through holes 140 in both ends thereof connected to the extending portions 200, such that the through holes 140 penetrate through the body 100. The through holes 140 may be formed in the centers of portions connecting the body 100 and the extending portions 200. Thus, the extending portions 200 may be partially connected to the body 100 through opposite sides of the through holes 140 in the both ends of the body 100.

The body 100 may have a reduced weight due to the windows 130 and the through holes 140. Further, an amount of resin used in forming the body 100 maybe reduced to thereby allow for reduced manufacturing costs. In particular, the body 100 has a frame structure through the windows 130 and the through holes 140, such that it may easily implement a spring back phenomenon. That is, the body 100 may have a structure capable of easily generating elasticity, thereby further being easily deformed by a user.

The deformation of the body 100 may be defined as relative positional movement of the body 100 with respect to the extending portions 200, to be described later.

FIGS. 4A and 4B schematically illustrate operational states of the jig apparatus 10. As illustrated in FIGS. 4A and 4B, the central portion of the body 100 in the length direction may move from a position thereof (see FIG. 4A) protruding toward the other surface 100b in a direction opposite to that of the extending portions 200 extending from the body 100, to a position thereof (see FIG. 4B) protruding toward the one surface 100a in the same direction as that of the extending portions 200 extending from the body 100, when both ends of the body 100 are fastened. In this case, the portions connecting the body 100 and the extending portions 200 may serve as hinges.

The extending portions 200 may be respectively provided on one end and the other end of the body 100 in the length direction. In addition, the extending portions 200 may be bent and extended from the body 100 in the same direction as each other and be integrally formed with the body 100.

The extending portions 200 may be extended from the one surface 100a directed in a direction in which the body 100 is bent, or may respectively extended from the one surface 100a and the other surface 100b of the body 100. The extending portions 200 may have a symmetrical structure in which they face each other on the both ends of the body 100. Hooks 210 having a predetermined size may be formed to protrude from surfaces of the extending portions 200 and face each other.

The hooks 210 may have a structure corresponding to the protrusions EG (see FIGS. 5-7) such that they may be engaged with the protrusions EG of the trays T and caught and fixed thereto.

The body 100 and the extending portions 200 may be formed integrally with each other through injection-molding, for example, and may be formed of a resin material having elasticity. Examples of the resin material may include an acrylonitrile-butadiene-styrene (ABS) resin, a polypropylene (PP) resin, a polycarbonate (PC) resin, a polyamide (PA) resin, or the like, but are not limited thereto. Further, a material such as a metal or alloy, may be included in the body 100 and the extending portions 200 in addition to the resin material.

A fastening method using the jig apparatus according to an exemplary embodiment of the present inventive concept will be explained with reference to FIGS. 5 through 7.

FIG. 5 schematically illustrates the laminate TS in which the trays T are loaded, the trays T having the light emitting devices 1 received therein.

As in FIG. 5, the laminate TS formed by stacking the trays T in which the light emitting devices 1 are received, therein, may be prepared. The trays T may have a plurality of cell structures capable of receiving the plurality of light emitting devices 1 therein, and include the protrusions EG respectively protruding from edges of both ends of the trays T, as the edge guides.

Each of the plurality of light emitting devices 1 may include a substrate 2 and an LED chip 3 mounted on the substrate 2.

Along with the laminate TS of the trays T, the jig apparatus 10 may be prepared to include the body 100 having a non-planar structure by bending the central portion of the body 100 so as to protrude toward the other surface 100b, and the extending portions 200 respectively bent and extended in the same direction, e.g., that of protruding from the one surface 100a, from the one end of the body 100 and from the other end of the body 100 in the length direction. The jig apparatus 10 may be prepared prior to the preparing of the laminate TS.

The jig apparatus 10 may be one illustrated in FIGS. 1 through 4, and therefore a detailed description thereof is substituted with the foregoing description in connection with FIGS. 1 through 4, and will be omitted hereinafter.

FIG. 6 schematically illustrates a process in which the jig apparatus is pre-fastened, e.g., temporarily fastened, to the tray laminate TS.

Referring to FIG. 6, the extending portions 200 may be engaged with and fixed to the protrusions EG respectively provided on edges of one ends of an upper tray T1 and a lower tray T2, among the plurality of trays T configuring the laminate TS. In this case, the jig apparatus 10 may be pre-fastened to one end of the laminate TS such that a protruding surface, the other surface 100b of the body 100 may be outwardly disposed.

Furthermore, in the same manner as that described above, another jig apparatus 10 may be pre-fastened to the other end, opposing to the edge of the one end of the laminate TS.

FIG. 6 illustrates only the upper tray T1 and the lower tray T2 in a state in which other trays T loaded between the upper tray T1 and the lower tray T2 are omitted, for the convenience of explanation.

FIG. 7 schematically illustrates a process in which the jig apparatus 10 is fastened to the laminate TS.

Referring to FIG. 7, the jig apparatus 10 may be fastened to the laminate TS by applying pressure to the center of the other surface 100b in a direction of an arrow illustrated in FIG. 7, in order to inwardly protrude the one surface 100a of the body 100. Through the spring back phenomenon due to the deformation of the body 100, the jig apparatus 10 may stably fasten the plurality of trays T loaded on one another, using tension applied to the body 100.

Further, the tension applied to the body 100 may be removed by returning a direction of protrusion of the body 100 to the original direction thereof, that is, a direction toward the outside of the laminate TS, whereby the jig apparatus 10 may be easily separated from the laminate TS.

In this manner, the jig apparatus 10 according to an exemplary embodiment of the present inventive concept may implement a one-touch type fastening structure using a spring back phenomenon, such that a binding process of the trays T may be further easily performed.

A taping method using tape according to the related art is disadvantageous in that a taping position is non-uniform depending on individual operators, an adhesive residue remains on the trays even after a removal of tape, and safety accidents may occur due to tools used for the removal of tape, for example, knifes, scissors and the like.

Contrary to this, in the fastening method using the jig apparatus 10 according to an exemplary embodiment of the present inventive concept, a fastening position may be fixed and the remaining material may not be present even after the removal of the jig apparatus 10, such that quality defects may not be generated and disadvantages occurring in the method according to the related art may be solved.

In particular, the jig apparatus 10 maybe advantageously reused as compared to disposable tape according to the related art. In addition, intuitive management and work process efficiency may be improved by differentiating individual colors of jig apparatuses 10. For example, abnormally processed products and normal shipment products may be distinguished, and the respective jig apparatuses 10 having different colors may be fastened thereto to thereby allow for a user's intuitive management. Further, the jig apparatuses 10 having different colors determined depending on respective customers may be attached to thereby facilitate the management thereof.

As set forth above, according to exemplary embodiments of the present inventive concept, the jig apparatus capable of simply fastening the loaded trays in a one-touch manner, and the fastening method using the same may be provided.

Various advantages and effects in exemplary embodiments of the present inventive concept are not limited to the above-described descriptions and may be easily understood through explanations of concrete embodiments of the present inventive concept.

While exemplary embodiments have been shown and described above, it will be apparent to those skilled in the art that modifications and variations could be made without departing from the spirit and scope of the present disclosure as defined by the appended claims.

What is claimed is:

1. A jig apparatus fastening loaded trays having light emitting devices received therein, the jig apparatus comprising:
a body having a bent structure in a length direction thereof; and
first and second extending portions respectively bent and extending from a first end and a second end of the body in the length direction thereof.

2. The jig apparatus of claim 1, wherein the body is bent at a predetermined angle, with respect to a center of a first surface of the body.

3. The jig apparatus of claim 2, wherein the angle ranges from 169° to 175°.

4. The jig apparatus of claim 2, wherein the first and second extending portions respectively extend from the first surface of the body.

5. The jig apparatus of claim 2, wherein the body has a stepped structure in which a second surface of the body protrudes along a circumference of an edge of the second surface.

6. The jig apparatus of claim 1, wherein the body includes windows penetrating therethrough.

7. The jig apparatus of claim 6, wherein the windows are respectively provided in regions between a central portion of the body in the length direction thereof and both ends of the body.

8. The jig apparatus of claim 1, wherein the body includes concave portions recessed toward centers of both side surfaces connecting the first and second ends thereof.

9. The jig apparatus of claim 1, wherein the body includes through holes in the first and second ends thereof connected to the first and second extending portions, the through holes penetrating through the body.

10. The jig apparatus of claim 1, wherein the body includes an acrylonitrile-butadiene-styrene (ABS) resin, a polypropylene (PP) resin, a polycarbonate (PC) resin, a polyamide (PA) resin, or the like.

11. The jig apparatus of claim 1, wherein the first and second extending portions include respective hooks protruding from surfaces of the first and second extending portions, such that the respective hooks face each other.

12. A fastening method, comprising:
preparing a laminate by loading a plurality of trays in which light emitting devices are received;
preparing a first jig apparatus including a body having a bent structure by bending a central portion of the body so as to protrude toward a first surface of the body, and first and second extending portions respectively bent and extending from a first end and a second end of the body in a length direction thereof;
allowing the first and second extending portions to be engaged with and fixed to protrusions respectively provided on edges of one ends of an upper tray and a lower tray among the plurality of trays loaded in the laminate, while pre-fastening the first jig apparatus to one end of the laminate such that a protruding surface of the body is outwardly disposed;
pre-fastening a second jig apparatus to an other end of the laminate, opposing to the one end of the laminate; and
fastening the first jig apparatus to the laminate by applying pressure to a center of the first surface of the body in such a manner the protruding central portion of the body protrudes toward a second surface of the body.

13. The fastening method of claim 12, wherein the body is bent at a predetermined angle based on the central portion thereof, and the angle ranges from 169° to 175°.

14. The fastening method of claim 12, wherein the first and second extending portions include respective hooks protruding from surfaces of the first and second extending portions, such the respective hooks face each other.

15. The fastening method of claim 12, wherein each of the light emitting devices includes a substrate and an LED chip mounted on the substrate.

16. A jig apparatus fastening loaded trays having light emitting devices received therein, the jig apparatus comprising:
a body having a first surface and a second surface opposing the first surface; and
extending portions extending from the first surface of the body in an extending direction, wherein
the body has a bent structure with respect to a central portion of the body such that when both ends of the body are fastened, the central portion moves from a position protruding toward the second surface of the body in a direction opposite to the extending direction, to a position protruding toward the first surface in the extending direction.

17. The jig apparatus of claim 16, wherein the body is bent at a predetermined angle, with respect to a center of the first surface of the body.

18. The jig apparatus of claim 17, wherein the angle ranges from 169° to 175°.

19. The jig apparatus of claim 16, wherein the extending portions have first and second extending portions respectively bent and extending from first and second ends of the body in the length direction thereof.

20. The jig apparatus of claim 16, wherein the extending portions include hooks protruding from surfaces of the extending portions, such that the hooks face each other.
